(19) United States
(12) Patent Application Publication
(10) Pub. No.: US 2012/0042897 A1
(43) Pub. Date: Feb. 23, 2012

(54) FLOSSING TOOL AND DISPENSER

(76) Inventor: Justin M. RAYBOULD, Bolling AFB, DC (US)

(21) Appl. No.: 13/213,193

(22) Filed: Aug. 19, 2011

Related U.S. Application Data
(60) Provisional application No. 61/375,890, filed on Aug. 23, 2010.

(51) Int. Cl. A61C 15/04

(52) U.S. Cl. 132/325; 132/327

(57) ABSTRACT

A flossing tool and dispenser. The flossing tool and dispenser can include a body having a handle end and an operative end, a cavity defined within the body and disposed substantially at the handle end, a first tong and a second tong disposed at the operative end, and defining a gap for tensioning a strand of dental floss therebetween, a recess disposed between the handle end and the operative end, an aperture extending between the cavity and the recess, and a cam disposed within the recess, and movable between a first position and a second position, wherein the cam is positioned such that, when the cam is in the first position, the cam impedes the movement of the strand of floss by causing the strand of floss to be pinched simultaneously at two locations along the length of the strand of floss, and, when the cam is in the second position, the cam does not impede the movement of the strand of floss.

### CROSS-REFERENCE TO RELATED APPLICATIONS

This application claims priority to U.S. Provisional Patent Application No. 61/375,890, filed Aug. 23, 2010 and entitled FLOSSING TOOL AND DISPENSER, the entire contents of which are hereby incorporated by reference.

### BACKGROUND

Regular flossing of teeth is an important component of a dental hygiene routine. Combined with brushing, flossing promotes healthy teeth and gums by removing plaque, food particles, and other foreign material from the gaps between teeth. However, despite its hygienic and medical benefits, many individuals do not floss regularly, if at all.

Known flossing techniques typically involve threading a string of floss between a pair of teeth, using both hands to hold each end of the string, and then moving the string back and forth between the teeth while keeping the string tense. Many people find such techniques both cumbersome and unpleasant, as one's fingers must be inserted into the mouth and must maintain contact with the floss string, which becomes coated with saliva, plaque, and other substances. Additionally, during the flossing process, the user needs to frequently replace used floss with clean floss, and there exists a high likelihood of contamination of the clean floss by the substances and bacteria that become deposited on the user's fingers during the process. These deposits also reduce friction between the user's hands and the floss string, making it difficult to maintain the tension necessary for effective flossing.

Some flossing devices are single-use and utilize a single short length of floss fixedly coupled to a handle. Due to the short length of floss, such devices must be discarded after every session, which results in unnecessary waste and cost to the user. Furthermore, typical use of such devices results in using the same length of floss in various areas of the mouth, promoting bacteria transfer and reducing the effectiveness of the flossing procedure. Other flossing devices incorporate floss advancement mechanisms that increase manufacturing costs and complexity. Additionally, certain devices retain used floss within the device, and/or do not adequately separate clean floss from used floss, thereby promoting bacterial cross-contamination.

Consequently, there exists a need for a device that allows one to floss conveniently and comfortably, while at the same time maintaining sufficient tension in the floss string and minimizing the likelihood of cross-contamination between the used and clean lengths of floss. Furthermore, there exists a need for a simple, low-cost, reusable device that sufficiently isolates clean floss from used floss and substantially impedes cross-contamination.

### SUMMARY

According to at least one exemplary embodiment, a flossing tool and dispenser is described. The flossing tool and dispenser can include a body having a handle end and an operative end, a cavity defined within the body and disposed substantially at the handle end, a first tong and a second tong disposed at the operative end, and defining a gap for tensioning a strand of dental floss therebetween, a recess disposed between the handle end and the operative end, an aperture extending between the cavity and the recess, and a cam disposed within the recess, and movable between a first position and a second position, wherein the cam is positioned such that, when the cam is in the first position, the cam impedes the movement of the strand of floss by causing the strand of floss to be pinched simultaneously at two locations along the length of the strand of floss, and, when the cam is in the second position, the cam does not impede the movement of the strand of floss.

### BRIEF DESCRIPTION OF THE FIGURES

FIG. 1a is a front perspective view of a first embodiment of a flossing tool.

FIG. 1b is a rear perspective view of a first embodiment of a flossing tool.

FIG. 2a is a top view of a first embodiment of a flossing tool with a cam in a first position.

FIG. 2b is a top view of a first embodiment of a flossing tool with a cam in a second position.

FIG. 3a is a three-quarters view of a second embodiment of a flossing tool.

FIG. 3b is a three-quarters view of a second embodiment of a flossing tool.

FIG. 4a is a detail view of a second embodiment of a flossing tool.

FIG. 4b is a detail view of a second embodiment of a flossing tool with a cam in a first position.

FIG. 4c is a detail view of a second embodiment of a flossing tool with a cam in a second position.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

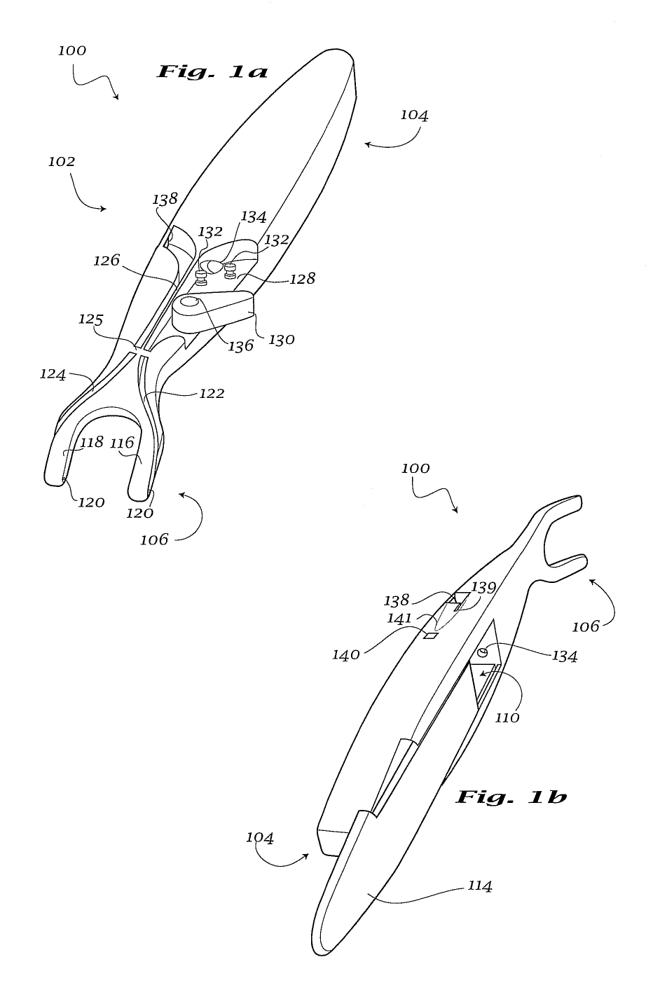

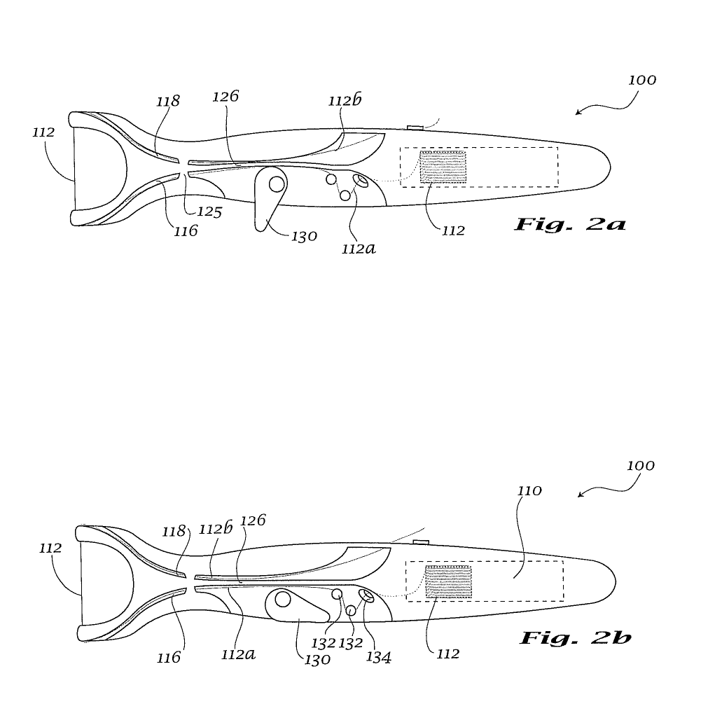

FIGS. 1a-2b show a first exemplary embodiment of a dental flossing tool 100. Flossing tool 100 may include an elongated body 102 having a handle end 104 and an operative end 106, and may be formed from plastic, metal, or any other desired material, which may be non-porous. Handle end 104 may include a cavity 110 disposed therein for receiving a quantity of dental floss 112 in a spool configuration, or in any other desired configuration. Cavity 110 may be selectively covered by cover 114, which may be slidably, threadably, or otherwise frictionally coupled to body 102, as shown, for example, in FIG. 1b.

Operative end 106 may include first and second tongs 116, 118. Tongs 116, 118 may be substantially parallel to each other, and may be curved or angled away from the longitudinal axis of body 102. Furthermore, tongs 116, 118 may be rigid and not movable. Each of tongs 116, 118 may have a bore, slit or passage 120 defined at the terminal end thereof. Extending towards handle end 104 from passage 120 of first tong 116 may be a first channel 122, and extending towards handle end 104 from passage 120 of second tong 118 may be a second channel 124. As first and second channels 122, 124 continue towards handle end 104 through body 102, channels 122, 124 may converge such that the distance between channels 122, 124 is decreased until a narrow divider 126 is defined therebetween. Subsequently, channels 122, 124 may run parallel to each other, separated by divider 126. A bridge 125 can extend over a portion of channels 122, 124, which can facilitate maintaining the strand of floss 112 within the channels.

First channel 122 may extend between first tong 116 and recess 128. Recess 128 may be located substantially between operative end 106 and handle end 104 of body 102. Disposed within recess 128 may be cam 130 and at least one post or spindle 132. Furthermore, an aperture 134 may be defined in the surface of recess 128, and can be in communication with cavity 110, thereby allowing a strand of floss 112 to be threaded from cavity 110 into recess 128. The at least one spindle 132 may have a shaft and a cap, the cap having a diameter greater than the diameter of the shaft. Spindle 132 may further be fixedly coupled to body 102, may be rotatably coupled to body 102, or may have a rotatable portion thereon, such that spindle 132, or a portion thereof, can rotate about its longitudinal axis. At least one spindle 132 can facilitate tensioning a strand of floss 112 when floss is wound around at least one spindle 132 prior to being threaded through channels 122, 124. At least one spindle 132 may further have a base, the base having a diameter greater than the diameter of the shaft. At least one spindle 132 can thus facilitate maintaining the strand of floss 112 substantially elevated above the surface of recess 128, thereby reducing the likelihood of the strand of floss moving under cam 130.

Second channel 124 may extend between second tong 118 and an aperture 138. Aperture 138 may be located substantially between operative end 106 and handle end 104 of body 102. Clip 140 may be located proximate to aperture 138 and may be configured such that a strand of floss 112 may be fastened thereto. Clip 140 may include a sharpened edge such that excessive floss length may be removed by the user as desired. Aperture 138 may further include a slit 139, which may function as a guide for the user to pull the floss therethrough and towards clip 140. Additionally, disposed between aperture 138 and clip 140 may be a depression 141. Depression 141 may be a concavity defined in body 102 and may aid the user in grasping floss 112.

As shown in FIGS. 2a-2b, divider 126 may be resiliently flexible so as to allow divider 126 to assume an bent or curved shape when a force, oblique or perpendicular to the length of divider 126, is applied thereto. When the force is withdrawn, divider 126 may reassume a linear shape. Divider 126 can be sufficiently flexible so that, when force is applied, divider 126 can come in contact with the thereto-opposed wall of second channel 124. Thus, if a length of floss 112 is disposed within second channel 124, it may be pinched between divider 124 and the thereto-opposed wall of second channel 124, thereby inhibiting the movement of floss 112.

Cam 130 may be rotatably mounted on a shaft 136, proximate to divider 126 such that a clearance exists between divider 126 and cam 130. Cam 130 may further be an eccentric cam. Thus, the clearance between the edge of cam 130 and divider 126 may vary depending on the position of cam 130. For example, as shown in FIG. 2a, when cam 130 is in a first position, the edge of cam 130 can come into contact with divider 126 and can further depress divider 126 in such that divider 126 contacts the thereto-opposed wall of channel 124. The strand of floss 112 may therefore be simultaneously pinched both between cam 130 and divider 126 and between divider 126 and the thereto-opposed wall of channel 124. Conversely, as shown in FIG. 2b, when cam 130 is in a second position, there may be sufficient clearance between cam 130 and divider 126 for a strand of floss 112 to pass freely therebetween.

In operation, the user may place a quantity of floss 112 into cavity 110 of flossing tool 100. One end of floss 112 may then be threaded through aperture 134 and wound around at least one spindle 132. Winding floss 112 around at least one spindle 132 may serve to increase tension in the floss as it is being threaded through flossing tool 100, and may reduce the likelihood of an excessive length of floss unwinding from cavity 110. With cam 130 in the second position, floss 112 may then be threaded between cam 130 and divider 126, through first channel 122, passages 120, second channel 124, and through aperture 138, as illustrated in FIG. 2b. The floss may then be fastened to clip 140, thereby maintaining tension in the length of floss 112 that is disposed between at least one spindle 132 and clip 140. Once floss 112 is fastened, the user may place cam 130 into the first position, as illustrated in FIG. 2a, thereby placing the edge of cam 130 in contact with divider 126, and displacing divider 126 such that it is in contact with the thereto-opposed wall of second channel 124. As a result, floss 112 can simultaneously become pinched both between cam 130 and divider 126, and between divider 126 and the thereto-opposed wall of second channel 124. Due to the floss being pinched in two locations, tension in the length of floss 112 that is threaded through operative end 106 is further increased, providing a taut floss line disposed between tongs 116, 118.

After using flossing tool 100, the user may desire to advance floss 112 such that a clean length of floss 112a is disposed between tongs 116, 118. To advance the floss, the user can move cam 130 into the second position, such that the edge of cam 130 is no longer in contact with divider 126. As a result, floss 112 may be pulled freely through channels 122, 124 until a clean length of floss 112a is disposed between tongs 116, 118, while the used length of floss 112b passes through channel 124 and out aperture 138. The user may then attach the used length of floss 112b to clip 140, and, if desired, remove any excess length of used floss 112b. Subsequently, the user may return cam 130 into the first position, thereby pinching and imparting tension to floss 112, as described above. Furthermore, both the clean floss 112a and the used floss 112b can be simultaneously pinched by moving cam 130 into the first position. It should also be appreciated that divider 126 facilitates maintaining clean length of floss 112a and used length of floss 112b separate from each other, thereby preventing clean length of floss 112a and used length of floss 112b from contacting each other and reducing the likelihood of contamination of the clean floss. Furthermore, used floss 112b is not retained within body 102 but is rather guided outside body 102 where it can be cut and disposed of by the user.

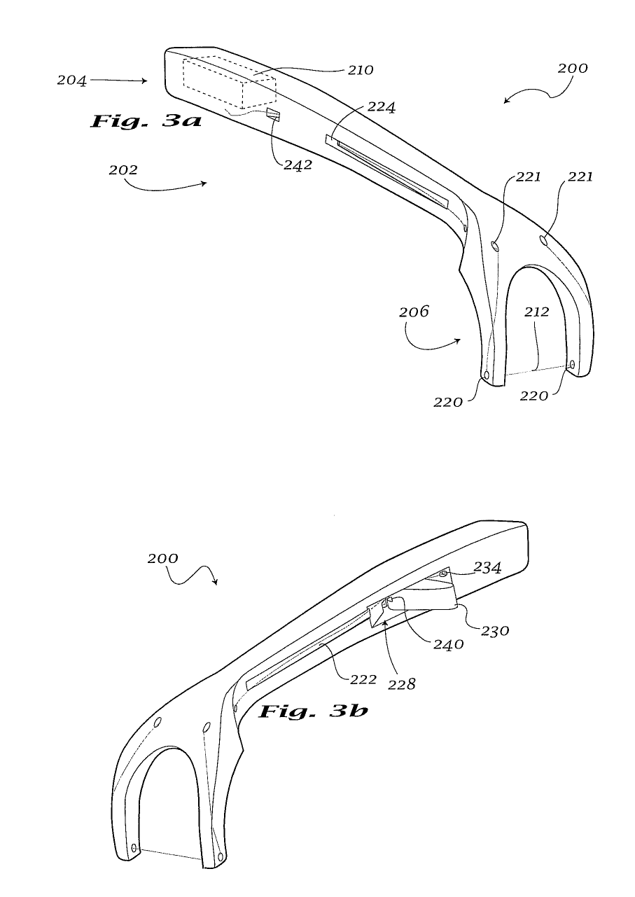

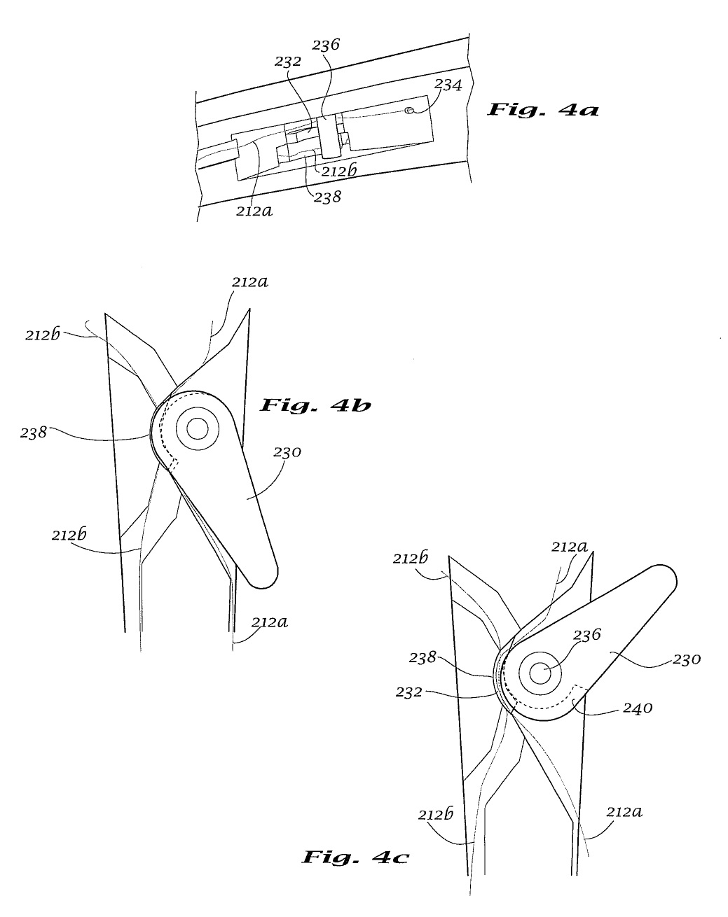

FIGS. 3a-4c illustrate a second exemplary embodiment of a dental flossing tool 200. Flossing tool 200 may include an elongated body 202 having a handle end 204 and an operative end 206. Handle end 204 may include a cavity 210 disposed therein for receiving a quantity of dental floss 212 in a spool configuration, or in any other desired configuration. Cavity 210 may be selectively covered by a cover (not shown), which may be slidably, threadably, or otherwise frictionally coupled to body 202. Operative end 204 may include first and second tongs 216, 218. Tongs 216, 218 may be substantially parallel to each other, and may be curved or angled away from the longitudinal axis of body 102. Furthermore, tongs 216, 218 may be rigid and not movable. Each of tongs 216, 218 may have a first bore, slit or passage 220 defined at the terminal end thereof.

Disposed substantially between operative end 206 and handle end 204 may be a recess 228. Extending from recess 228 towards operative end 206 may be a first channel 222 and a second channel 224, the channels 222, 224 being disposed on opposite sides of body 202 and capable of receiving a strand of floss 212 therein. Both channels 222, 224 may be in communication with recess 228. Disposed forward of channels 222, 224 may be bores, slits or passages 221. Passages 221 may facilitate passing the strand of floss 212 towards tongs 216, 218 and may also facilitate maintaining tension in the portion of floss 212 that is disposed at operative end 206.

Disposed within recess 228 may be a cam 230, a tab 232, an aperture 234, a shaft 236, and a wall 238. Aperture 234 may be defined in the surface of recess 228 and can be in communication with cavity 210, thereby allowing a strand of floss 212 to be threaded from cavity 210 into recess 228. Tab 232 may protrude from wall 238 towards shaft 236. Cam 230 may be rotatably mounted on shaft 236 proximate to wall 238 such that passages are defined above and below tab 232, and between wall 238 and cam 230. Cam 230 may further include a notch 240 having a size and shape complementary to tab 232, such that tab 232 can be received within notch 240. A clean strand of floss 212a may thus pass from aperture 234, above tab 232, and into channel 222, and a used strand of floss 212b may pass from channel 224, below tab 232, and out through an aperture 242 defined in body 202 of flossing tool 200, as shown in FIG. 4a.

Cam 230 may be an eccentric cam. Thus, the distance between the edge of cam 230 and wall 238 may vary depending on the position of cam 230. For example, as shown in FIG. 4b, when cam 230 is in a first position, the edge of cam 230 can come into contact with wall 238, thereby simultaneously pinching both clean floss 212a and used floss 212b between cam 230 and wall 238. Conversely, as shown in FIG. 4c, when cam 230 is in a second position, there may be sufficient clearance between cam 230 and wall 238 for a strand of floss 212 to pass freely therebetween.

In operation, the user may place a quantity of floss 212 into cavity 210 of flossing tool 200. One end of floss 212 may then be threaded through aperture 234. With cam 230 in the second position, floss 112 may then be threaded between cam 230 and wall 238, through first channel 222, passages 221, and passages 220, second channel 224, and through aperture 242, as illustrated in FIGS. 3a-3b. The user may then place cam 230 into the first position, as illustrated in FIG. 4b, thereby placing the edge of cam 230 in contact with wall 238. As a result, floss 212 becomes simultaneously pinched between cam 230 and wall 238 at two points along the length of floss 212. Consequently, tension in the length of floss 212 that is threaded through operative end 206 is further increased, providing a taut floss line disposed between tongs 216, 218.

After using flossing tool 200, the user may desire to advance floss 212 such that a clean length of floss is disposed between tongs 216, 218. To advance the floss, the user can move cam 230 into the second position, such that the edge of cam 230 is no longer in contact with wall 238, as shown in FIG. 4c. As a result, floss 212 may be pulled freely through channels 222, 224 until a clean length of floss is disposed between tongs 216, 218. The user may then return cam 230 into the first position, thereby pinching and imparting tension to floss 212, as described above. It should be appreciated that tab 232 maintains clean lengths of floss 212a and used lengths of floss 212b separate from each other, thereby preventing clean lengths of floss 212a and used lengths of floss 212b from contacting each other and reducing the likelihood of contamination of the clean floss. Furthermore, used floss 212b is not retained within body 202 but is rather guided outside body 202 where it can be cut and disposed of by the user.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A flossing tool and dispenser, comprising:
a body having a handle end and an operative end;
a cavity defined within the body and disposed substantially at the handle end;
a first tong and a second tong disposed at the operative end, and defining a gap for tensioning a strand of dental floss therebetween;
a recess disposed between the handle end and the operative end;
an aperture extending between the cavity and the recess; and
a cam disposed within the recess, and movable between a first position and a second position;
wherein the cam is positioned such that, when the cam is in the first position, the cam impedes the movement of the strand of floss by causing the strand of floss to be pinched simultaneously at two locations along the length of the strand of floss, and, when the cam is in the second position, the cam does not impede the movement of the strand of floss.

2. The flossing tool and dispenser of claim 1, further comprising:
a first channel extending substantially from the first tong to the recess; and
a second channel extending substantially from the second tong to an aperture defined in the body;
wherein a clean length of the strand of floss is received within the first channel and a used length of the strand of floss is received within the second channel.

3. The flossing tool and dispenser of claim 2, wherein:
the first channel and the second channel converge so as to define a flexible divider therebetween; and
when the cam is in the first position, the cam exerts a force on the divider such that the divider contacts a thereto-opposed wall of the second channel, thereby simultaneously pinching the strand of floss at a first location between the cam and the divider and a second location between the divider and the thereto-opposed wall of the second channel.

4. The flossing tool and dispenser of claim 3, wherein, when the cam is in the first position, the length of the strand of floss disposed between the first location and the second location is tensioned.

5. The flossing tool and dispenser of claim 1, wherein:
the recess further comprises a tab extending from a wall thereof; and
the cam further comprises a notch having a size and shape complementary to the tab, such that when the cam is in the first position, the tab is received within the notch.

6. The flossing tool and dispenser of claim 5, wherein:
a clean length of the strand of floss passes above the tab and between the cam and the wall of the recess;
a used length of the strand of floss passes below the tab and between the cam and the wall of the recess; and
when the cam is in the first position, the cam simultaneously pinches the strand of floss at a first location above the tab and at a second location below the tab.

7. The flossing tool and dispenser of claim 6, further comprising:
a first channel extending substantially from the first tong to the recess; and
a second channel extending substantially from the second tong to an aperture defined in the body and in communication with the recess;
wherein a clean length of the strand of floss is received within the first channel and a used length of the strand of floss is received within the second channel.

8. The flossing tool and dispenser of claim 6, wherein, when the cam is in the first position, the length of the strand of floss disposed between the first location and the second location is tensioned.

9. The flossing tool and dispenser of claim 1, wherein the first tong and the second tong are parallel to each other.

10. The flossing tool and dispenser of claim 1, wherein the first tong and the second tong are not movable.

11. The flossing tool and dispenser of claim 1, wherein the first tong and the second tong are not parallel to the longitudinal axis of the body.

12. The flossing tool and dispenser of claim 1, further comprising at least one spindle disposed within the recess.

13. A flossing tool and dispenser, comprising:
a body;
a cavity defused within the body for receiving a spool of dental floss;
a first tong and a second tong, defining a gap for tensioning a strand of dental floss therebetween; and;
a cam disposed between the cavity and the pair of tongs, and movable between a first position and a second position;
wherein, when the cam is in the first position, the cam impedes the movement of the strand of floss by causing the strand of floss to be pinched simultaneously at two locations along the length of the strand of floss, and, when the cam is in the second position, the cam does not impede the movement of the strand of floss.

14. The flossing tool and dispenser of claim 13, further comprising:
a first channel extending substantially between the first tong and the cam; and
a second channel extending substantially between the second tong and the cam;
wherein a clean length of the strand of floss is received within the first channel and a used length of the strand of floss is received within the second channel.

15. The flossing tool and dispenser of claim 14, wherein:
the first channel and the second channel converge so as to define a flexible divider therebetween; and
when the cam is in the first position, the cam exerts a force on the divider such that the divider contacts a thereto-opposed wall of the second channel, thereby simultaneously pinching the strand of floss at a first location between the cam and the divider and a second location between the divider and the thereto-opposed wall of the second channel.

16. The flossing tool and dispenser of claim 15, wherein, when the cam is in the first position, the length of the strand of floss disposed between the first location and the second location is tensioned.

17. The flossing tool and dispenser of claim 13, wherein the cam is disposed within a recess defined in the body.

18. The flossing tool and dispenser of claim 17, wherein:
the recess further comprises a tab extending from a wall thereof; and
the cam further comprises a notch having a size and shape complementary to the tab, such that when the cam is in the first position, the tab is received within the notch.

19. The flossing tool and dispenser of claim 18, wherein:
a clean length of the strand of floss passes above the tab and between the cam and the wall of the recess;
a used length of the strand of floss passes below the tab and between the cam and the wall of the recess; and
when the cam is in the first position, the cam simultaneously pinches the strand of floss at a first location above the tab and at a second location below the tab.

20. The flossing tool and dispenser of claim 19, wherein, when the cam is in the first position, the length of the strand of floss disposed between the first location and the second location is tensioned.
